(19) United States
(12) Patent Application Publication
(10) Pub. No.: US 2014/0109692 A1
(43) Pub. Date: Apr. 24, 2014

(54) ROLLING TORQUE TOOL

(71) Applicant: K-Line Industries, Inc., Holland, MI (US)

(72) Inventors: Brian T. Potter, Fennville, MI (US); Karl F. Reith, Auburn, IN (US)

(73) Assignee: K-Line Industries, Inc., Holland, MI (US)

(21) Appl. No.: 13/947,187

(22) Filed: Jul. 22, 2013

Related U.S. Application Data
(60) Provisional application No. 61/717,272, filed on Oct. 23, 2012.

(51) Int. Cl. G01L 3/06

(52) U.S. Cl. CPC G01L 3/06
USPC 73/862.191

(57) ABSTRACT

A torque measurement tool measures the rolling torque of a bearing. The tool includes a bar weldment including a scale bar and a centered socket, and further includes a pair of slides slidably engaging the scale bar. Each slide has a thumb screw lock to fix a selected location and a rod adapted to engage the rotatable portion of the preloaded bearing (or engage a component attached thereto). A related method includes adjusting the slides to engage rods of the torque measurement tool with a rotatable bearing portion in a balanced condition, and using a torque wrench to obtain a reading of the torque required to move the rotatable bearing portion.

This application claims benefit under 35 USC §119(e) of provisional application Ser. No. 61/717,272, filed Oct. 23, 2012, entitled ROLLING TORQUE TOOL, the entire contents of which are incorporated herein by reference.

### BACKGROUND

The present invention relates to a tool for measuring rolling torque of a bearing or bushing or other type of friction surface, including preloaded bearings and items that ride on bearings and bushings.

It is known to measure torque in many different environments, including measuring rolling torque of bearings. However, measuring rolling torque on an installed bearing is difficult for several reasons. For example, it is difficult to grip the bearing in a balanced manner to obtain an accurate reading. Further, the environment may have components that interfere with gripping the bearing, and sometimes the environment of the installation is dirty, contaminated, or otherwise not conducive for obtaining a reliable accurate reading. Concurrently, it is often not desirable to use expensive and/or delicate measurement tools. Some environments require sterility, and it is difficult to provide a measuring tool that is both sanitary and effective.

### SUMMARY OF THE PRESENT INVENTION

In one aspect of the present invention, a torque measurement tool is provided for measuring break-free torques as well as rolling torque of a bearing, the bearing having rotatable and non-rotatable portions. The tool includes a bar weldment including a scale bar and a centered socket adapted for connection to a torque wrench, and further includes a pair of slides engaging the scale bar, each slide having a lock to fix a selected location on the bar and having an elongated member adapted to engage the rotatable portion of the bearing or a component attached thereto.

In another aspect of the present invention, a method of measuring rolling torque of a bearing is provided, where the bearing has rotatable and non-rotatable portions. The method comprises providing a bar weldment including a scale bar and a centered driver member adapted for connection to a torque wrench, providing a pair of slides operably engaging the scale bar and having an elongated member extending from each of the slides for engaging the rotatable portion of the bearing at equal distances from the centered driver member, and engaging the elongated members with the rotatable portion of the bearing or a component rotatable with the rotatable portion of the bearing. The method further includes rotating the bar and hence rotating the rotatable portion using a torque wrench engaged with the socket, and recording a measured value of torsional resistance from the torque wrench during the step of rotating.

In another aspect of the present invention, a torque measurement tool includes a scale bar and a connector on the scale bar that is adapted for connection to a torque wrench, and a pair of spaced-apart elongated gripper members on the scale bar that are adapted to engage the rotatable portion of a bearing or a component attached thereto.

In another aspect of the present invention, a method of measuring rolling torque of a bearing comprises connecting a scale bar to a torque wrench, providing a pair of spaced-apart elongated gripper members on the scale bar, and engaging the elongated gripper members with a rotatable portion of one of a bearing or a component attached thereto while using the torque wrench to measure a rolling torque of the bearing.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a rolling torque tool embodying the present invention.

FIGS. 2-4 are side, end, and exploded side views of FIG. 1.

FIGS. 5 and 6 are side views of the tool of FIG. 1 used to measure rolling torque on two different installed bearings, and FIGS. 5A-5D are plan views of variations of FIG. 5.

FIGS. 7-8 are side and end views of a modified tool similar to FIGS. 2-3.

### DETAILED DESCRIPTION OF PREFERRED EMBODIMENTS

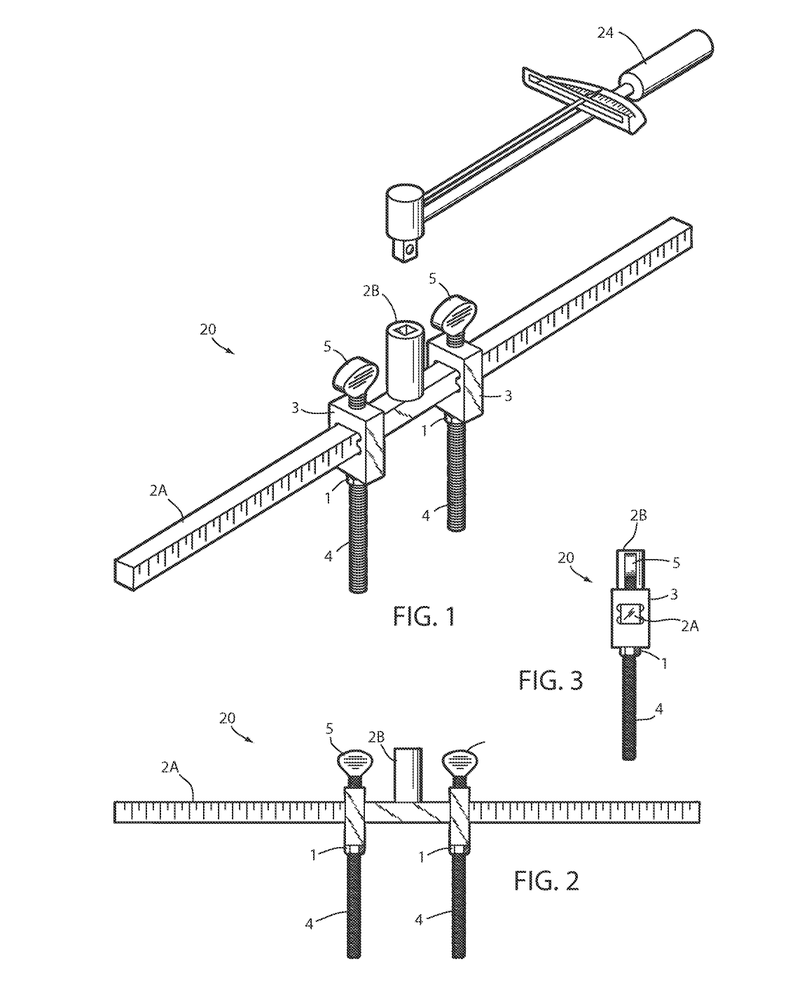

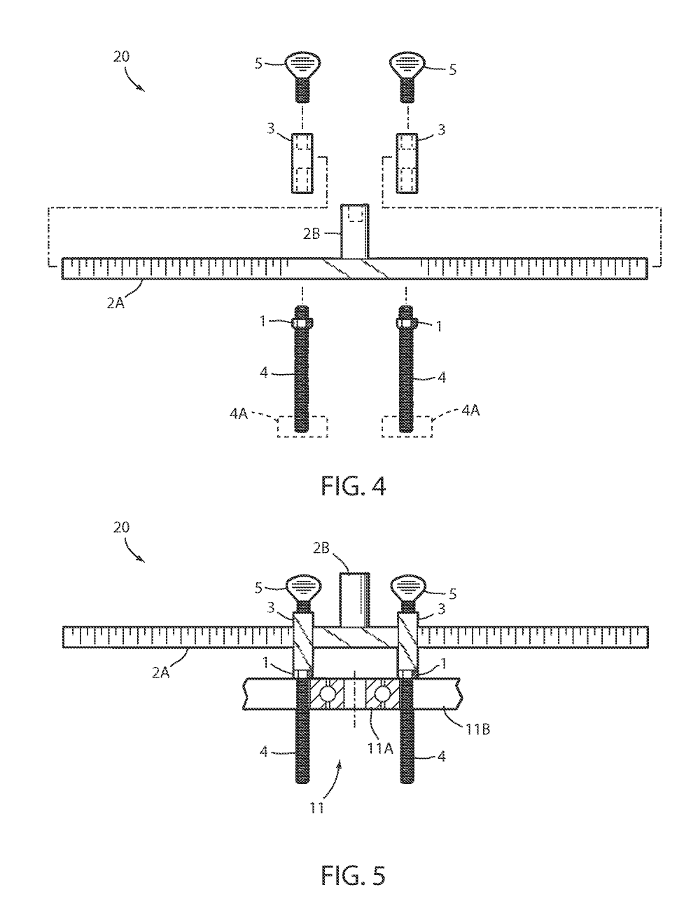

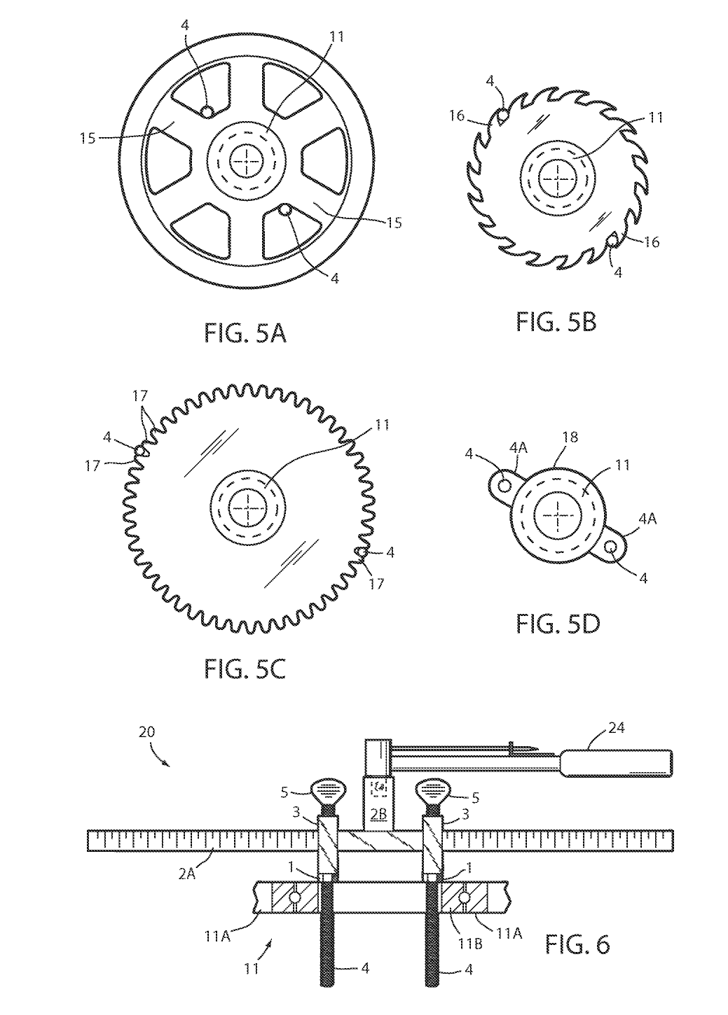

A torque measurement tool 20 (FIGS. 1-4) measures the rolling torque of a preloaded bearing 11 with stationary non-rotatable bearing component 11A and rotatable bearing component 11B (FIG. 5). The tool 20 is also capable of measuring break-free torques required to initiate rotation. The tool 20 (FIG. 4) includes a bar weldment 2 including a scale bar 2A with a square cross section and a centered socket 2B (also called “driver” herein) welded to a center of the scale bar 2A. The torque wrench 24 (FIGS. 1 and 6) engages socket 2B to measure torsional resistance while rotating tool 20 and the rotatable bearing part (2A or 2B, see FIGS. 5-6).

The scale bar 2A includes indicia/scale extending in opposite directions from a centered socket 2B down at least one side of the scale bar 2A. The tool 20 further includes a pair of slides 3 slidably engaging the scale bar 2A. Each slide 3 has a lock (set screw or thumb screw 5) to fix a selected location, and also includes a threaded rod 4 (also called a “gripper member” herein) extending from the slide 3 with lock nut 1 to fix it to the slide. The rods 4 have a free end 4A adapted to engage the rotatable bearing component 11B of the preloaded bearing 11 (or engage a component 12 attached thereto, see for example FIGS. 5A-5D). It is contemplated that the free end of the rods 4 can be an unthreaded rod, or a threaded rod, or can include a friction foot 4B for frictionally engaging the rotatable bearing component 11B (or component attached to rotatably bearing component 11B). By using the indicia on scale bar 2A, the slides 3 can be equally spaced from the centered socket 2B, thus facilitating a more accurate reading.

A related method (see FIG. 5) includes adjusting the slides 3 to an optimal position to positively engage the rods 4 of the torque measurement tool 20 with a rotatable bearing component 11B (or a component connected to the rotatable bearing component 11B). Using a torque wrench 24 engaged with the socket 2B, the tool 24 can be used to obtain a reading of the torque required to move the rotatable bearing component 11B. The indicia on the scale bar 2A helps assure that the two slides 3 are equally spaced from the centered socket 2B, thus helping to assure a balanced loading and most accurate torque reading.

It is contemplated that the torque measurement tool 20 can engage different bearings and/or bearing-attached components connected to the bearing. For example, compare FIGS. 5A-5D, where FIG. 5A shows the rods 4 engaging radial arms (spokes) 15 of a fly wheel 11, and FIG. 5B shows rods 4 engaging concavities defined by saw teeth 16, FIG. 5C shows the rods 4 engaging gear teeth 17, and FIG. 5D shows rods 4 with a friction feet 4A engaging an outer surface 18 of a rotatable bearing component 11 by the friction feet 4A. Also, see FIG. 6 which shows the rotatable bearing portion 11B as being inside of the non-rotatable bearing portion 11A, and with the rods 4 engaging the (internal) rotatable bearing portion 11B.

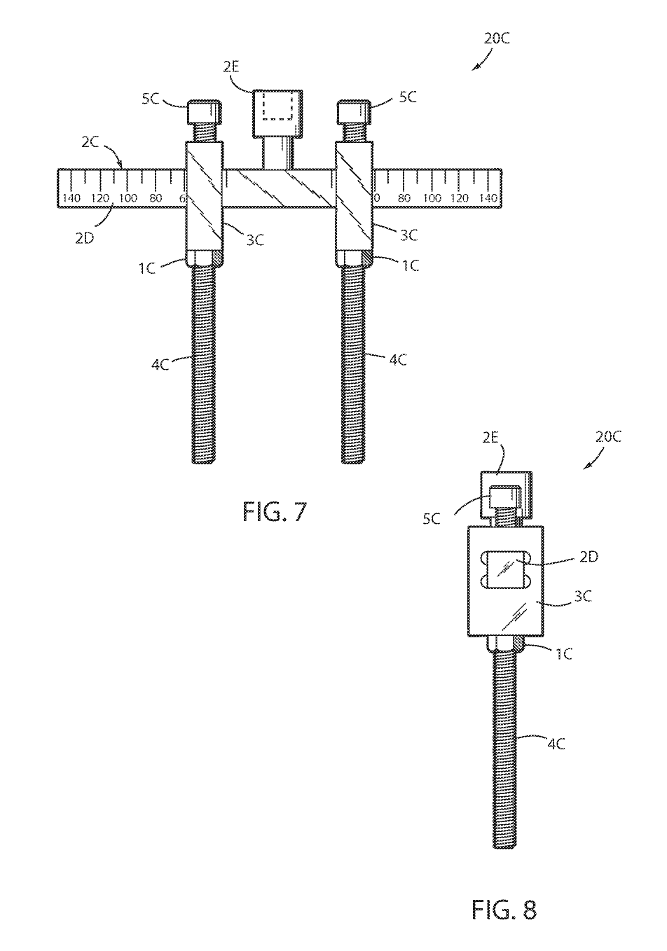

It is contemplated that the present tool and its components can be made in various sizes and configurations. For example, see FIGS. 7-8, which disclose tool 20C having components similar to tool 20, and that are identified using identical numbers. However, as will be understood by a person skilled in this art, the tool 20C has a modified machine-type set screw 5C, a lock nut 1C, two slides 3C, two threaded rods 4C with increased cross section, and a centered socket 5E welded to bar 2D.

Even though the present embodiment is disclosed as measuring a preloaded bearing, it is contemplated that the present innovation applies to other bearings or bushings, and to any lubricious surface, and also applies to other types of friction surfaces or devices that could be considered a bearing or bushing. For example, it is contemplated that the present innovation could be used on a shaft or other device that rides on bushings, such as a crankshaft in an internal combustion engine. The present innovation is also not limited to only machinery, but for example could be used to measure hip and joint replacements that require measuring the amount of force needed to rotate the replacement hip once implanted, as well as measuring force to rotate beforehand. (i.e. break-free torques for initial movement).

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A torque measurement tool for measuring rolling torque of a bearing, the bearing having rotatable and non-rotatable portions, comprising:
a bar weldment including a scale bar and a centered socket adapted for connection to a torque wrench; and
a pair of slides operably engaging the scale bar, each slide having a lock to fix a selected location on the bar and having an elongated member adapted to engage the rotatable portion of the bearing or a component attached thereto.

2. The tool defined in claim 1, wherein the slides non-rotatably engage the scale bar.

3. The tool defined in claim 2, wherein the scale bar includes indicia along its length for indicating a distance from the centered socket.

4. The tool defined in claim 1, wherein the elongated member is a threaded rod with a lock nut.

5. The tool defined in claim 1, wherein the lock on each of the slides is a thumb screw with an end positioned to engage the scale bar.

6. A method of measuring rolling torque of a bearing, the bearing having rotatable and non-rotatable portions, comprising:
providing a bar weldment including a scale bar and a centered driver member adapted for connection to a torque wrench;
providing a pair of slides operably engaging the scale bar and having an elongated member extending from each of the slides for engaging the rotatable portion of the bearing at equal distances from the centered driver member;
engaging the elongated members with the rotatable portion of the bearing or a component rotatable with the rotatable portion of the bearing;
rotating the scale bar and hence rotating the rotatable portion using a torque wrench engaged with the socket; and
recording a measured value of torsional resistance from the torque wrench during the step of rotating.

7. The method defined in claim 6, wherein each slide has a lock to fix a selected location on the scale bar.

8. The method defined in claim 6, including a step of locking the slides on the scale bar in a selected position, and noting a specific data point on the scale bar.

9. A torque measurement tool comprising:
a scale bar and a connector on the scale bar that is adapted for connection to a torque wrench; and
a pair of spaced-apart elongated gripper members on the scale bar that are adapted to engage the rotatable portion of a bearing or a component attached thereto.

10. The torque measurement tool defined in claim 9, wherein the gripper members are adjustably positioned on the scale bar.

11. The torque measurement tool defined in claim 9 wherein the elongated members include a threaded rod.

12. A method of measuring rolling torque of a bearing comprising:
connecting a scale bar to a torque wrench;
providing a pair of spaced-apart elongated gripper members on the scale bar; and
engaging the elongated gripper members with a rotatable portion of one of a bearing or a component attached thereto while using the torque wrench to measure a rolling torque of the bearing.

13. The method defined in claim 12, wherein the gripper members include threaded rods.
